(19) United States
(12) Patent Application Publication
(10) Pub. No.: US 2016/0199765 A1
(43) Pub. Date: Jul. 14, 2016

(54) NONWOVEN FABRIC, AIR PURIFIER USING THE SAME, AND METHOD FOR PRODUCING NONWOVEN FABRIC

(71) Applicant: Panasonic Intellectual Property Management Co., Ltd., Osaka (JP)

(72) Inventors: Koji MOTOMURA, Osaka (JP); Takayoshi YAMAGUCHI, Osaka (JP); Yuki YOSHIOKA, Osaka (JP)

(21) Appl. No.: 14/977,976

(22) Filed: Dec. 22, 2015

(30) Foreign Application Priority Data
Jan. 8, 2015 (JP) 2015-002648
Mar. 5, 2015 (JP) 2015-043958

(51) Int. Cl. B01D 39/16; D04H 1/541; D04H 1/00

(52) U.S. Cl. CPC B01D 39/1623; D04H 1/005; D04H 1/541

(57) ABSTRACT

A nonwoven fabric includes a nanofiber. The nanofiber includes a core portion and a sheath portion covering at least a part of a surface of the core portion. The core portion includes a first polymer. The sheath portion includes a second polymer. The second polymer is smaller in polarity than the first polymer.

### CROSS REFERENCE TO RELATED APPLICATION

This application is based on Japanese Patent Application (No. 2015-002648) filed on Jan. 8, 2015 and Japanese Patent Application (No. 2015-043958) filed on Mar. 5, 2015, the contents of which are incorporated herein by reference.

### 1. TECHNICAL FIELD

The present disclosure relates to a nonwoven fabric containing a fiber (nanofiber) having a sheath-core structure and an air purifier using the same, and a method for producing a nonwoven fabric.

### 2. DESCRIPTION OF THE RELATED ART

Nonwoven fabrics of a fiber are utilized for various applications in addition to filter materials. In recent years, from the viewpoint that the surface area can be made large, it is also investigated to utilize a nonwoven fabric using a nanofiber having a fiber diameter in the order of from nm to sub-μm for applications, such as a filter material, etc. For example, WO2008/130019 proposes a wet type nonwoven fabric including a short fiber A that is a nanofiber and a binder fiber B having a single fiber fineness of 0.1 dtex or more. WO2008/130019 teaches that such a nonwoven fabric can be utilized for a filter and the like.

In the filter material application, a high collection performance (e.g., a dust collection performance, etc.) is required. In general, however, if the collection performance is increased, a pressure loss becomes large, and the practicability is lowered.

An object of the present disclosure is to provide a nonwoven fabric with an excellent collection performance while suppressing a pressure loss and an air purifier including the same, and also a method for producing a nonwoven fabric.

### SUMMARY

One aspect of the present disclosure is concerned with a nonwoven fabric including:

a nanofiber including a core portion and a sheath portion covering at least a part of a surface of the core portion,

wherein the core portion includes a first polymer,

wherein the sheath portion includes a second polymer, and

wherein the second polymer is smaller in polarity than the first polymer.

Another aspect of the present disclosure is concerned with a nonwoven fabric including:

a nanofiber including a core portion and a sheath portion covering at least a part of a surface of the core portion,

wherein the core portion includes a first polymer,

wherein the sheath portion includes a second polymer, and

wherein the second polymer is smaller in dielectric constant than the first polymer.

A still another aspect of the present disclosure is concerned with a nonwoven fabric including:

a nanofiber including a core portion and a sheath portion covering at least a part of a surface of the core portion,

wherein the core portion includes a first polymer;

wherein the sheath portion includes a second polymer;

wherein the second polymer is a polyurethane; and

wherein the first polymer being a polymer that is higher in hydrolysis resistance than the second polymer.

A separate aspect of the present disclosure is concerned with an air purifier including:

a suction portion for gas;

an ejection portion for the gas; and

the above-described nonwoven fabric disposed between the suction portion and the ejection portion.

A still separate aspect of the present disclosure is concerned with a method for producing a nonwoven fabric, including:

a first step of preparing a first solution containing a first polymer or a precursor thereof and a second polymer having smaller polarity than the first polymer, and

a second step of producing a nanofiber by an electrostatic force from the first solution in a nanofiber-forming space and accumulating the produced nanofiber, thereby forming a nonwoven fabric,

wherein the nanofiber includes a core portion and a sheath portion covering at least a part of a surface of the core portion,

wherein the core portion includes the first polymer; and

wherein the sheath portion includes the second polymer.

It is possible to provide a nonwoven fabric capable of increasing collection properties, such as dust collection properties, etc., while suppressing a pressure loss. Such a nonwoven fabric is suitable for a filter material application of an air purifier, or the like.

### BRIEF DESCRIPTION OF THE DRAWINGS

FIG. 1 is a view diagrammatically illustrating a configuration of a system for obtaining a nonwoven fabric in a method for producing a nonwoven fabric according to an embodiment of the present disclosure.

FIG. 2 is a front view diagrammatically illustrating a discharge portion 42A of FIG. 1.

FIG. 3 is a side view diagrammatically illustrating a discharge portion 42A of FIG. 1.

FIG. 4 is an enlarged cross-sectional view diagrammatically illustrating a discharging body.

FIG. 5 is a partially cutaway perspective view diagrammatically illustrating an air purifier according to an embodiment of the present disclosure.

FIG. 6 is an electron microscopic photograph of a nonwoven fabric of Example 1.

FIG. 7 is a photograph enlarging a portion A of FIG. 6.

FIG. 8 is an electron microscopic photograph of a nonwoven fabric of Comparative Example 1.

### DETAILED DESCRIPTION OF THE EXEMPLARY EMBODIMENTS

### Nonwoven Fabric

### First Embodiment

A nonwoven fabric according to a first embodiment of the present disclosure includes a nanofiber including a core portion and a sheath portion covering at least a part of a surface of the core portion, wherein the core portion includes a first polymer, and the sheath portion includes a second polymer. Here, the second polymer is smaller in polarity (smaller in dielectric constant) than the first polymer.

In view of the fact that the sheath portion of a nanofiber having a sheath-core structure includes a polymer with small polarity (or low dielectric constant), electrostatic properties of the nanofiber, eventually electrostatic properties of the nonwoven fabric, can be enhanced. As a result, a collection performance, such as a dust collection performance, etc. (specifically, collection efficiency of a dust or the like), is enhanced.

Meanwhile, the electric field spinning method is an industrially excellent technique capable of relatively easily producing a fiber, such as a nanofiber, etc., by using a polymer melt or solution. However, since a polymer with small polarity (or low dielectric constant) is considerably restricted in terms of conditions of electric field spinning, it is difficult to produce a fiber including such a polymer on an industrial scale by the electric field spinning method. A polymer which is liable to be subjected to electric field spinning is large in polarity and low in electrostatic properties, and hence, it is hard to give a collection performance, such as a dust collection performance, etc., to the nanofiber itself. In the present embodiment, the core portion includes a first polymer that is larger in polarity (or higher in dielectric constant) than a second polymer included in the sheath portion of the sheath-core structure. For that reason, a nonwoven fabric can be easily formed by means of electric field spinning while ensuring the collection performance of a nanofiber, and also, the productivity of a nonwoven fabric can be increased.

In view of the fact that the nonwoven fabric is constituted of a nanofiber, its surface area becomes large, and the collection performance can be further increased due to high electrostatic properties of the sheath portion. Namely, even if a nonwoven fibrous structure is not made dense, a high collection performance can be ensured, and hence, the matter that a pressure loss becomes large can be suppressed. For example, the nanofiber constituting the nonwoven fabric is formed by the electric field spinning method.

The nanofiber may have an exposed portion where a part of a surface of the core portion is exposed. In addition, in the surface of the core portion, an area of the exposed portion may be larger than an area of the sheath portion. In such a nanofiber, since the sheath portion formed of the second polymer is formed partially on the surface of the core portion, and hence, the surface of the nanofiber becomes coarse, whereby the collection performance of the nonwoven fabric can be further increased.

An amount of the second polymer may be, for example, 10 to 1,000 parts by mass, preferably 20 to 500 parts by mass, and more preferably 50 to 200 parts by weight based on 100 parts by mass of the first polymer. In the case where the amount of the second polymer falls within such a range, it becomes easy to allow the second polymer to adhere onto the surface of the core portion (namely, easy to form the sheath portion). In addition, it becomes easy to produce a nanofiber by means of electric field spinning.

The constitution of the nonwoven fabric is hereunder more specifically described.

### (First Polymer)

The first polymer that forms the core portion of the fiber is larger in polarity (or higher in dielectric constant) than the second polymer. It is to be noted that the polarity of the polymer can be expressed by a dielectric constant (specific dielectric constant ∈).

The dielectric constant (specific dielectric constant ∈) of the first polymer is, for example, 2.7 or more, and preferably 3 or more, or 3.4 or more at a frequency of 10⁶ Hz. Although an upper limit of the dielectric constant is not particularly limited, it may be, for example, 8 or less, or 5 or less. These lower limit value and upper limit value can be arbitrarily combined. The dielectric constant of the first polymer may also be, for example, 2.7 to 8, or 3 to 5. In the case where the dielectric constant of the first polymer falls within such a range, the fiber is liable to be formed by means of electric field spinning.

The electrostatic properties of the first polymer tend to be low as compared with the second polymer. A volume resistivity of the first polymer is preferably 10¹⁶Ω·cm or less, and more preferably 5×10¹⁵Ω·cm or less, or 10¹⁵Ω·cm or less under conditions at 25° C. and 50% RH (relative humidity).

Examples of the first polymer include polyether sulfone (PES), a polysulfone, a polyester (for example, an aliphatic polyester, a polyalkylene terephthalate, e.g., polyethylene terephthalate, etc., or the like), a polyamide, a polyimide (PI), polyacrylonitrile (PAN), polyvinyl alcohol, polyethylene oxide, and the like. These polymers may be a homopolymer, or may be a copolymer. The core portion may include one kind of the first polymer, or may include two or more kinds of the first polymer. PES, PAN, and/or PI, or the like is used from the viewpoints that the solution is liable to be prepared; and that the electric field spinning is liable to be achieved (and excellent spinnability is revealed).

Although a weight average molecular weight M_{w} of the first polymer varies depending upon the kind of the polymer, it is, for example, 30,000 to 120,000, and preferably 50,000 to 100,000, or 50,000 to 80,000. As for the first polymer that forms the core portion (in the case where plural polymers are contained, each of the polymers), its molecular weight distribution width is preferably narrow as far as possible from the viewpoints that the electric field spinning is liable to be achieved together with the second polymer; and that the nanofiber of a sheath-core structure is liable to be formed. The molecular weight distribution width of the first polymer that forms the core portion is preferably narrower than a molecular weight distribution width of the second polymer. As for the first polymer, a ratio of the weight average molecular weight M_{w} to a number average molecular weight Mₙ (=M_{w}/Mₙ) is preferably 1.1 to 1.6, and more preferably 1.1 to 1.4.

It is to be noted that in the present specification, the weight average molecular weight and the number average molecular weight of the polymer are values determined from a molecular weight distribution as measured by means of gel permeation chromatography.

### (Second Polymer)

The second polymer that adheres onto the surface of the core portion to form the sheath portion is smaller in polarity (or smaller in dielectric constant) than the first polymer.

A dielectric constant (specific dielectric constant ∈) of the second polymer is preferably less than 2.7, and more preferably 2 to 2.65, or 2.2 to 2.6 at a frequency of 10⁶ Hz.

A difference between the dielectric constant of the first polymer and the dielectric constant of the second polymer may be, for example, 0.5 or more, preferably 0.7 or more, and more preferably 0.9 or more.

The second polymer are desirably higher in electrostatic properties than the first polymer from the viewpoint of ensuring the collection performance, such as a dust collection performance, etc. A volume resistivity of the second polymer is, for example, 10¹⁵Ω·cm or more, and preferably 10¹⁶Ω·cm or more, or 10¹⁷Ω·cm or more under conditions at 25° C. and 50% RH. In the case where the volume resistivity of the second polymer falls within such a range, the collection performance of the nonwoven fabric can be further increased.

Examples of the second polymer include polyolefins, such as polyethylene, polypropylene (PP), an ethylene-propylene copolymer, etc.; aromatic vinyl resins, such as polystyrene, etc.; acrylic resins (e.g., polymers containing an acrylic acid ester and/or a methacrylic acid ester as a monomer unit, etc.), such as polymethyl methacrylate, etc.; and the like. The second polymer may be a homopolymer, or may be a copolymer. The sheath portion may include one kind of the second polymer, or may include two or more kinds of the second polymer. Polyolefins, such as PP, etc., are used from the viewpoint that the sheath portion is liable to be allowed to adhere to the core portion.

Although a weight average molecular weight M_{w} of the second polymer varies depending upon the kind of the polymer, it is, for example, 30,000 to 150,000, and preferably 40,000 to 120,000, or 50,000 to 100,000. As for the second polymer (in the case where plural polymers are contained, each of the polymers), its molecular weight distribution width is preferably wide as far as possible from the viewpoints that the electric field spinning is liable to be achieved together with the first polymer; and that the nanofiber of a sheath-core structure is liable to be formed. As for the second polymer, a ratio of the weight average molecular weight M_{w} to a number average molecular weight Mₙ (=M_{w}/Mₙ) is preferably 1.8 to 3.0, and more preferably 2.0 to 3.0.

In the nanofiber, the sheath portion has only to cover at least a part of the surface of the core portion and may also cover the whole of the surface of the core portion. From the viewpoint of increasing the collection performance, such as a dust collection performance, etc., for example, a part of the surface of the core portion is covered by the sheath portion, and the remaining portion of the surface of the core portion is exposed, thereby forming an exposed portion.

In the surface of the core portion, an area of the exposed portion is preferably larger than an area of the sheath portion from the viewpoint of increasing the collection performance. A ratio of the area Sₑ of the exposed area to the area Sₛ of the sheath portion (=Sₑ/Sₛ) may be, for example, 1.1 to 5.0, and preferably 1.5 to 4.0, or 2.0 to 3.0. The area ratio Sₑ/Sₛ can be, for example, calculated in such a manner that in an electron microscopic photograph, the areas Sₑ and Sₛ of the exposed portion and the sheath portion of the nanofiber existent in a prescribed region (for example, a region having an area in the range of 1 μm², or the like) are measured, and Sₑ is divided by Sₛ. In addition, an average value may also be calculated by performing the same computation in plural places (for example, 10 places).

An average fiber diameter of the nanofiber is, for example, 5 nm or more and less than 1,000 nm, preferably 10 to 900 nm, or 20 to 800 nm, and more preferably 100 to 500 nm, or 20 to 500 nm.

Here, the average fiber diameter is, for example, determined by measuring a diameter of one place in each of arbitrary ten fibers and averaging these measured values. The diameter of the fiber is a diameter of a cross section perpendicular to the length direction of the fiber. In the case where such a cross section is not circular, a maximum diameter may be considered as the diameter.

The nanofiber constituting the nonwoven fabric may include a known additive in addition to the first polymer and the second polymer, if desired. A content of the additive may be 5% by mass or less of the whole of the nanofiber constituting the nonwoven fabric (or the whole of the nonwoven fabric).

A thickness of the nonwoven fabric can be chosen within the range of from about 1 to 1,000 μm per sheet, and it is, for example, 10 to 700 μm, and preferably 50 to 600 μm, or 100 to 500 μm.

The nonwoven fabric according to the present embodiment includes the nanofiber in which the second polymer constituting the sheath portion is smaller in polarity (or smaller in dielectric constant) than the first polymer constituting the core portion, and hence, it is excellent in the collection performance, such as a dust collection performance, etc. In addition, in view of the fact that the nonwoven fabric according to the present embodiment is a nonwoven fabric made of a nanofiber, a pressure loss can be made small. Therefore, the nonwoven fabric according to the present embodiment is suitable for allowing a variety of fluids (liquids and/or gases) to pass therethrough, thereby removing unnecessary components from the fluid or cleaning up the fluid, and especially suitable for use as a filter material of an air purifier.

### Second Embodiment

A nonwoven fabric according to a second embodiment of the present disclosure includes a nanofiber including a core portion and a sheath portion covering at least a part of a surface of the core portion, wherein the core portion includes a first polymer, and the sheath portion includes a second polymer. Here, the first polymer is a polyurethane, and the second polymer is higher in hydrolysis resistance than the first polymer. Such a nonwoven fabric has high strength and is able to suppress deterioration.

Examples of the first polymer include polyether sulfone (PES), polysulfone, an aromatic polyester (for example, a polyalkylene terephthalate, e.g., polyethylene terephthalate, etc., or the like), a polyamide, a polyimide (PI), polyacrylonitrile (PAN), and the like. These polymers may be a homopolymer, or may be a copolymer. The core portion may include one kind of the first polymer, or may include two or more kinds of the first polymer. PES, PAN, and/or PI, or the like is used from the viewpoints that the deterioration to be caused due to hydrolysis is suppressed; that the polymer solution is liable to be prepared; and that the electric field spinning is liable to be achieved (and excellent spinnability is revealed).

Although a weight average molecular weight M_{w} of the first polymer varies depending upon the kind of the polymer, it is, for example, 30,000 to 120,000, and preferably 50,000 to 100,000, or 50,000 to 80,000. As for the first polymer, a ratio of the weight average molecular weight M_{w} to a number average molecular weight Mₙ (=M_{w}/Mₙ) is, for example, 1.1 to 3.0.

It is to be noted that in the present specification, the weight average molecular weight and the number average molecular weight of the polymer are values determined from a molecular weight distribution as measured by means of gel permeation chromatography.

The polyurethane that is the second polymer is a polymer having a urethane bond (—O—C(═O)—NH—) and is obtained through a reaction of a polyisocyanate compound with a polyol compound. The polyurethane may be an aliphatic polyurethane and may also be a polyether polyurethane, a polyester polyurethane, a polycarbonate polyurethane, a polycaprolactone polyurethane, or the like according to the kind of the polyol compound. The polyurethane may be used solely or in combination of two or more kinds thereof. A weight average molecular weight M_{w} of the polyurethane is, for example, 30,000 to 200,000, and preferably 40,000 to 150,000. As for the polyurethane, a ratio of the weight average molecular weight M_{w} to a number average molecular weight Mₙ (=M_{w}/Mₙ) is preferably 1.8 to 3.0, or 2.0 to 3.0. In the case where M_{w} or the ratio M_{w}/Mₙ falls within such a range, the sheath portion is more liable to be formed.

In the nanofiber, the sheath portion has only to cover at least a part of the surface of the core portion and may cover the whole of the surface of the core portion. From the viewpoint of taking a balance between hydrolysis resistance and tensile strength, for example, the whole of the surface of the core portion is covered by the sheath portion as far as possible, and for example, a thickness of the sheath portion is uniform as far as possible. From such viewpoints, in a cross section perpendicular to the axial direction of the nanofiber, Tₘᵢₙ/Tₘₐₓ that is a ratio of a minimum value Tₘᵢₙ of the thickness of the sheath portion to a maximum value Tₘₐₓ of the thickness of the sheath portion is, for example, 0.8 to 1, and preferably 0.9 to 1. The ratio Tₘᵢₙ/Tₘₐₓ may also be less than 0.8.

The minimum value Tₘᵢₙ and the maximum value Tₘₐₓ of the thickness of the sheath portion can be measured from an image of a transmission electron microscope (TEM) of the nanofiber. Specifically, first of all, arbitrary plural places (for example, ten places) in which the cross section perpendicular to the length direction of the nanofiber can be observed in the TEM image are chosen. Then, the minimum value Tₘᵢₙ and the maximum value Tₘₐₓ of the thickness of the sheath portion are measured in the respective places, and the ratio Tₘᵢₙ/Tₘₐₓ is calculated, followed by averaging. An average value can be thus calculated.

A fiber diameter of the nanofiber can be properly chosen within the range described with respect to the first embodiment.

In the case where an average of D_{f}/D_{c} that is a ratio of a fiber diameter D_{f} of the nanofiber to a diameter D_{c} of the core portion is set to 1.4 to 5, the strength of the nonwoven fabric is liable to be increased, and such case is advantageous from the standpoint of suppressing deterioration of the nonwoven fabric. In particular, in the case of combining the polyurethane as the second polymer with the first polymer that is higher in hydrolysis resistance than the second polymer, by allowing the ratio of the diameter of the nanofiber to the diameter of the core portion to fall within the foregoing range, an effect for suppressing deterioration of the nonwoven fabric is liable to be obtained.

Here, the diameter of the nanofiber is a diameter of the cross section perpendicular to the length direction of the fiber. In the case where such a cross section is not circular, a maximum diameter may be considered as the diameter. The diameter of the core portion is a diameter of the core portion in the cross section perpendicular to the length direction of the fiber. The diameter of the nanofiber and the diameter of the core portion can be measured from cross-sectional photographs of the respective fibers. In the case where a cross-sectional shape of the core portion is not circular, a maximum diameter may be considered as the diameter. For example, the ratio of the diameter of the nanofiber to the diameter of the core portion is measured in arbitrary plural places (for example, ten places) of a cross-sectional photograph of the nonwoven fabric, and an average value obtained by averaging the measured values falls within the foregoing range.

The nanofiber constituting the nonwoven fabric may further include a known additive, if desired.

A thickness of the nonwoven fabric can be chosen within the range of from about 1 to 1,000 μm per sheet, and it is, for example, 10 to 700 μm, and preferably 10 to 600 μm, or 20 to 500 μm.

### (Production Method of Nonwoven Fabric)

The nonwoven fabric according to each of the first embodiment and the second embodiment of the present disclosure may be, for example, produced by the electric field spinning method using a molten mixture of the first polymer and the second polymer; however, preferably, the nonwoven fabric can be obtained by the electric field spinning method using a solution containing both the first polymer (or its precursor) and the second polymer. Specifically, the nonwoven fabric can be produced through a first step of preparing a solution (first solution) containing the first polymer or its precursor and the second polymer; and a second step of producing a fiber by an electrostatic force from the first solution in a fiber-forming space and accumulating the produced fiber, thereby forming a nonwoven fabric. In the second step, on the occasion of producing a fiber, the first polymer forms the core portion, and the sheath portion including the second polymer is formed so as to cover at least a part of the surface of this core portion, due to a difference in polarity (or dielectric constant) (or a difference in hydrolysis resistance) between the first polymer and the second polymer. It is to be noted that in the case where the first polymer is a polyimide or the like, by using, as the first solution, a solution containing a polyimide precursor (e.g., a polyamide acid, etc.) and the second polymer, the polyimide (first polymer) may be produced from the polyimide precursor by properly heating in a production process of a nonwoven fabric.

### (First Step)

In the first step, the first solution may be prepared by dissolving the first polymer (or its precursor) and the second polymer in a solvent. There is a difference in polarity (or dielectric constant or hydrolysis resistance) (preferably, a large difference) between the first polymer (or its precursor) and the second polymer. Therefore, solvents which are liable to dissolve the respective first polymer (or its precursor) and second polymer therein are different from each other, and a solution in which both of the first polymer (or its precursor) and the second polymer are uniformly dissolved is hardly prepared. For that reason, in preparing the first solution, at least a good solvent (first solvent) for the first polymer (or its precursor) and a good solvent (second solvent) for the second polymer are used, and a solvent (third solvent) capable of increasing an affinity (or compatibility) with the first solvent and the second solvent may be used in combination.

For example, the first polymer solution containing the first polymer (or its precursor) and the second polymer solution containing the second polymer are prepared, respectively, and these polymer solutions are mixed to prepare the first solution. More specifically, the first step preferably includes a step (a) of preparing the first polymer solution containing the first polymer (or its precursor) and the first solvent for dissolving the first polymer (or its precursor) therein; a step (b) of preparing the second polymer solution containing the second polymer and the second solvent for dissolving the second polymer therein; and a step (c) of mixing the first polymer solution and the second polymer solution. In the step (a), the step (b), and/or the step (c), the above-described third solvent can be used depending upon the kind of each of the first polymer (or its precursor) and the second polymer as well as the first solvent and the second solvent.

In the case where the second solvent is incompatible with the first solvent, even if the first polymer solution and the second polymer solution are mixed, the resulting mixture is in a phase-separated state, so that the first solution containing both the first polymer (or its precursor) and the second polymer is hardly obtained. In this case, on the occasion of mixing the first polymer solution and the second polymer solution in the step (c), for example, it is desired to adopt a measure for easily applying a shear force, such as stirring, etc. By mixing the first polymer solution and the second polymer solution by means of stirring or the like, it is possible to move at least a part of one of the first polymer (or its precursor) and the second polymer into the other polymer solution. Then, a solution containing both the first polymer (or its precursor) and the second polymer can be obtained. In the case where the mixture obtained in the step (c) is in a phase-separated state, the first step can further include a step (d) of separating the solution containing the first polymer (or its precursor) and the second polymer as the first solution from the mixture.

### (Step (a))

The first polymer can be prepared by dissolving the first polymer (or its precursor) in the first solvent.

The first solvent is not particularly limited so long as it is able to dissolve the first polymer (or its precursor) therein and to be removed by means of evaporation or the like. Examples of such a solvent include aprotic polar organic solvents, for example, methanol; ethylene glycol; acetone; nitriles, such as acetonitrile, etc.; amides (e.g., linear or cyclic amides, etc.), such as N, N-dimethylformamide (DMF), N, N-dimethylacetamide (DMAc), N-methyl-2-pyrrolidone (NMP), etc.; sulfoxides, such as dimethyl sulfoxide, etc.; and the like. These solvents may be used solely, or may be used in combination of two or more kinds thereof.

Although the first solvent varies depending upon the kind of the first polymer or its precursor, among the above-described solvents, aprotic polar organic solvents having a Rohrschneider's polarity parameter P′ of 5 or more (for example, 5 to 7.5) and the like are used. The first solvent is, for example, larger in polarity than the second solvent (namely, the second solvent is smaller in polarity than the first solvent). A difference in the polarity parameter P′ between the first solvent and the second solvent is 2 or more (for example, 2 to 8).

In addition, for example, the first solvent containing an amide is used. For example, in the case where the first polymer contains PES and/or PAN, the first solvent containing DMF and/or DMAc may be used. In the case where the first polymer contains PI or a precursor thereof, the first solvent containing NMP may be used.

If the molecular weight distribution of at least one of the first polymer and the second polymer is broad, it becomes easy to increase the affinity between the first polymer and the second polymer. For that reason, even in the case where the first polymer solution and the second polymer solution are incompatible with each other, it becomes easy to allow a first polymer molecular and a second polymer molecule to come close to each other in the step (c), and the both molecular chains are liable to be entangled with each other. Therefore, it becomes easy to move at least a part of the first polymer (or the second polymer) into the second polymer solution (or the first polymer solution). From the viewpoint that the polymer molecules are liable to be entangled with each other, for example, a molecular weight distribution width of each of the first polymer contained in the first polymer solution and the second polymer contained in the second polymer solution is wide. From the same viewpoint, the first polymer contained in the first polymer solution (in the case where plural polymers are contained, each of the polymers) may have plural peaks in the molecular weight distribution. An M_{w}/Mₙ ratio of the first polymer contained in the first polymer solution is preferably 1.8 to 3.0, or 2.0 to 3.0.

Since the polarity of the first solvent is relatively high, the case of moving the first polymer into the second polymer solution is easier than the case of moving the second polymer into the first polymer solution. For that reason, the molecular weight distribution width of the first polymer in the first polymer solution is large. In addition, in the case of preparing the first solution by moving the first polymer into the second solution, the molecular weight distribution width of the first polymer to be moved is limited to some extent. For that reason, the molecular weight distribution width of the first polymer contained in the first solution tends to become narrower than the molecular weight distribution width of the second polymer. The M_{w}/Mₙ ratio of the first polymer contained in the first polymer solution can be allowed to fall within the range described with respect to the first polymer that forms the core portion. In addition, by previously regulating the M_{w}/Mₙ ratio of the first polymer to be used for the first polymer solution to such a range, the amount of the first polymer remaining in the first polymer solution after the step (c) may be decreased.

The first polymer may contain a third solvent, if desired. As the third solvent, for example, an aprotic organic solvent having a polarity parameter P′ of 3 or more and less than 5, or the like can be used. Examples of such a third solvent include halogenated alkanes, such as dichloromethane, ethylene dichloride, chloroform, etc.; alcohols (e.g., C₂₋₄ alcohols, etc.), such as ethanol, n-propanol, isopropanol, etc.; cyclic ethers, such as tetrahydrofuran, dioxane, etc.; esters, such as ethyl acetate, etc.; methyl ethyl ketone; and the like. The third solvent may be used solely, or may be used in combination of two or more kinds thereof.

A concentration of the first polymer in the first polymer solution is, for example, 10 to 40% by mass, and preferably 15 to 30% by mass. In the case of such a concentration, it becomes easy to allow the first polymer molecule and the second polymer molecule to come closer to each other in the step (c).

The first polymer solution may contain a known additive which is used for the electric field spinning, if desired.

### (Step (b))

The second polymer solution can be prepared by dissolving the second polymer in the second solvent.

The second solvent is preferably one which is able to dissolve the second polymer therein and to be removed by means of evaporation or the like. For example, as the second solvent, a solvent that is smaller in polarity than the first solvent is used. The second solvent is preferably an aprotic organic solvent that is incompatible with the first solvent. Examples of such a second solvent include aprotic organic solvents having a polarity parameter P′ of less than 3 (for example, −1 or more and less than 3); and the like. Such an organic solvent may also be one which is generally called a low polar organic solvent or a non-polar organic solvent.

Specific examples of the second solvent include cycloalkanes, such as cyclohexane, methylcyclohexane, etc.; alkanes, such as n-hexane, etc.; aromatic hydrocarbons, such as toluene, xylene, etc.; symmetric ethers, such as diisopropyl ether, etc.; carbon tetrachloride; and the like. These solvents may be used solely, or may be used in combination of two or more kinds thereof.

In the case where the second polymer is a polyurethane, examples of the second solvent include aprotic polar organic solvents. Although the second solvent varies depending upon the kind of the first polymer or its precursor, an aprotic polar organic solvent having a Rohrschneider's polarity parameter P′ of 5 or more (for example, 5 to 7.5) is preferably used as the solvent. Examples of such a solvent include amides (e.g., linear or cyclic amides, etc.), such as N, N-dimethylformamide (DMF), N, N-dimethylacetamide (DMAc), N-methyl-2-pyrrolidone (NMP), etc.; sulfoxides, such as dimethyl sulfoxide, etc.; and the like. These solvents may be used solely, or may be used in combination of two or more kinds thereof.

For example, a solvent containing an amide is used. For example, in the case where the first polymer contains PES and/or PAN, a solvent containing DMF and/or DMAc may be used. In the case where the first polymer contains PI or a precursor thereof, a solvent containing NMP may be used.

A total concentration of the first polymer and the second polymer in the polymer solution is, for example, 10 to 60% by mass, and preferably 15 to 50% by mass.

The second polymer solution may contain the above-described third solvent, if desired. It is to be noted that the third solvent may be contained in any of the first polymer solution and the second polymer solution, or may be contained in the both polymer solutions.

A molecular weight distribution width of the second polymer which is used for the second polymer solution may be wider or narrower than, or the same degree as, that of the first polymer. In the case of using the second polymer having a certain degree of molecular weight distribution width, it becomes easy to entangle at least a part of the first polymer (fraction having a prescribed molecular weight distribution width) with the second polymer in the step (c). Therefore, even if optimization of the molecular weight of the first polymer is insufficient, the first solution can be easily obtained. An M_{W}/Mₙ ratio of the second polymer which is used for the second polymer solution can be allowed to fall within the range described with respect to the second polymer that forms the sheath portion.

A concentration of the second polymer in the second polymer solution is, for example, 10 to 40% by mass, and preferably 15 to 30% by mass. In the case of such a concentration, it becomes easy to allow the first polymer molecule and the second polymer molecule to come closer to each other in the step (c).

The second polymer solution may contain a known additive which is used for the electric field spinning, if desired.

### (Step (c))

In mixing the first polymer solution and the second polymer solution, known mixing devices (or stirring devices), for example, various mixers (e.g., a planetary mixer, etc.), various stirring machines equipped with a stirring wing (or a stirring blade), dispersers, and/or stirrers, or the like, can be used. In the case where the first polymer solution and the second polymer solution are in a phase-separated state from each other, for example, a mixing device that easily gives a large shear force, such as a planetary mixer, etc is used.

On the occasion of mixing, heating may be performed, if desired.

A stirring rate and a stirring time can be properly determined such that at least either one of the first polymer (or its precursor) and the second polymer can be moved into the other polymer solution. In the case where the mixture obtained in the step (c) is a uniform solution (single phase), it may be subjected to the electric field spinning step (second step) directly as the first solution, or may be subjected to the second step after removing a part of the solvent to concentrate the solution. In the case where the mixture obtained in the step (c) is in a phase-separated state, the first solution can be separated by subjecting the mixture to the step (d).

In the step (c), in addition to the first polymer solution and the second polymer solution, the above-described third solvent may be further mixed.

### (Step (d))

In the step (d), a solution containing the first polymer (or its precursor) and the second polymer is separated as the first solution from the mixture obtained in the step (c). More specifically, the first solution may be separated by allowing the mixture obtained in the step (c) to stand, thereby subjecting a solution containing the first polymer (or its precursor), the second polymer, and the second solvent to phase separation, and recovering this solution as the first solution.

It is to be noted that in the step (c), at least a part of the first polymer (e.g., a fraction having a relatively low molecular weight, etc.) is liable to move into the second polymer solution; however, there may be the case where a part of the second polymer moves into the first polymer solution. In the case where each of the phase-separated phases contains both the first polymer and the second polymer, the phase containing a larger amount of the moved polymer may be used as the first solution. All of the separated phases may be subjected as the first solution to electric field spinning. An M_{w}/Mₙ ratio of the first polymer contained in the first solution can be allowed to fall within the range described with respect to the first polymer that forms the core portion.

### (Second Step)

In the second step, the first solution obtained in the first step is fibrillated by means of electric field spinning, thereby forming a nonwoven fabric.

In the electric field spinning method, a nanofiber is produced by an electrostatic drawing phenomenon. More specifically, when the first solution is used as a raw material liquid for the electric field spinning, from the raw material liquid flown out into an electrically charged space, the solvent is gradually evaporated during flying in the space. According to this, though a volume of the raw material liquid gradually decreases during flying, the electric charges given to the raw material liquid remain in the raw material liquid. As a result, an electric charge density of the raw material liquid during flying in the space gradually increases. Then, at a point of time when the electric charge density of the raw material liquid increases, and the Coulomb force in the repulsion direction as generated in the raw material liquid surpass a surface tension of the raw material liquid, a phenomenon in which the raw material liquid is explosively drawn linearly is generated. This phenomenon is the electrostatic drawing phenomenon. According to the electrostatic drawing phenomenon, the nanofiber can be efficiently produced.

The first solution that is the raw material liquid contains the first polymer and the second polymer which are different in polarity (or dielectric constant or hydrolysis resistance) from each other. The first polymer is liable to be subjected to electrostatic drawing as compared with the second polymer, and hence, it forms a fibrous core portion by means of electrostatic drawing. The second polymer is hardly subjected to electrostatic drawing by only the second polymer; however, the second polymer is drawn together with the first polymer by means of electrostatic drawing, thereby forming a sheath portion so as to cover at least a part of the surface of the core portion. In this way, the nanofiber having a sheath-core structure is formed from the first solution.

By accumulating the nanofiber produced in a fiber-forming space on the surface of a base material, the nonwoven fabric according to the present embodiment is obtained. The formed nonwoven fabric may be exfoliated from the surface of the base material. In this case, the production method of a nonwoven fabric can further include a step of exfoliating the nonwoven fabric from the surface of the base material. Here, an exfoliative base material sheet, a belt of a carrying conveyor for carrying a fiber, or the like can be utilized as the base material. In addition, by using, as the base material, a base material having a nonwoven fibrous structure (e.g., a commercially available nonwoven fabric, etc.) and accumulating the nanofiber on the surface thereof, a nonwoven fabric in which the nonwoven fabric and the base material having a nonwoven fibrous structure are integrated with each other may be formed.

In the step of forming a nonwoven fabric, by using plural electric field spinning units, nanofibers which are different from each other may be produced and accumulated in the respective units, if desired. For example, the nonwoven fabric may be formed by producing and accumulating nanofibers which are different from each other in terms of a fiber diameter and/or a polymer formulation in the respective units. It is to be noted that the nanofiber diameter can be regulated by a state of the raw material liquid, a constitution of a discharging body, a size of an electric field formed by an electrostatic charging unit, or the like.

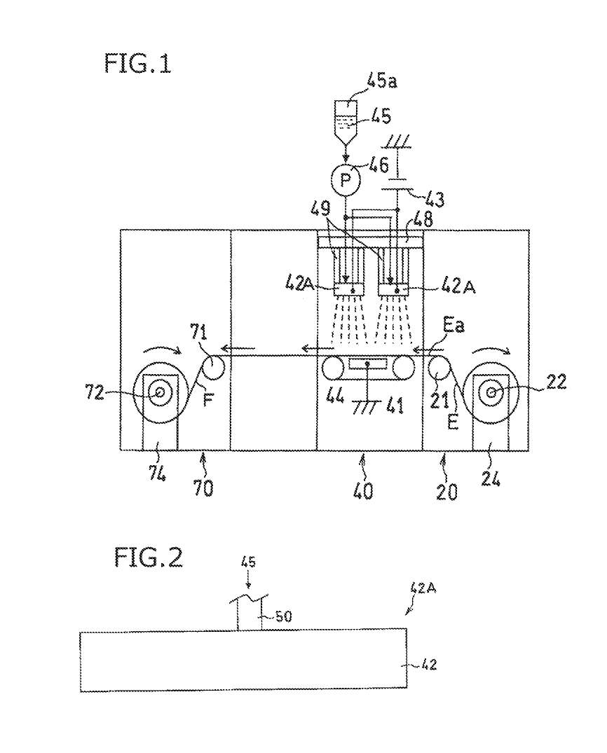

FIG. 1 is a view diagrammatically illustrating a configuration of a production system for carrying out a method for producing a nonwoven fabric according to an embodiment of the present disclosure. FIG. 1 is concerned with an example of the case of utilizing a base material E having a nonwoven fibrous structure.

The production system of FIG. 1 configures a production line for producing a nonwoven fabric. The production system is provided with a nonwoven fabric-forming apparatus 40 and a recovery apparatus 70 for recovering a formed nonwoven fabric. In the production system of FIG. 1, the base material E is carried from the upstream toward the downstream of the production line. In the base material E on the way of carrying, the formation of a nonwoven fabric of a nanofiber is performed at any time.

In the most upstream of the production system, a base material supply apparatus 20 having the base material E wound in a roll shape housed in the inside thereof is provided. The base material supply apparatus 20 unwinds the roll-shaped base material E and supplies the base material E into a separate apparatus adjacent to the own downstream side thereof. Specifically, the base material supply apparatus 20 rotates a supply reel 22 by a motor 24, thereby supplying the base material E wound around the supply reel 22 into a first carrying roller 21.

The unwound base material E is transferred into the nonwoven fabric-forming apparatus 40.

The nonwoven fabric-forming apparatus 40 includes an electric field spinning mechanism. More specifically, the electric field spinning mechanism is provided with a discharge portion 42A including a nozzle (discharging body) for discharging the raw material liquid, which is disposed in an upper portion within the apparatus; an electrostatic charging unit for electrostatically charging the discharged raw material liquid (first solution); and a carrying conveyor 41 for carrying a nonwoven fabric F from the upstream side toward the downstream side so as to be opposed to the discharge portion 42A. The carrying conveyor 41 functions as a collector portion for collecting a fiber together with the base material E, and a nanofiber discharged from the discharge portion 42A is accumulated on a surface (principal surface) of the base material E.

The electrostatic charging unit is configured of a voltage application device 43 for applying a voltage to the discharging body and a counter electrode 44 disposed in parallel to the carrying conveyor 41 and electrically connected thereto. The counter electrode 44 is grounded. According to this, a potential difference (for example, 20 to 200 kV) corresponding to the voltage applied by the voltage application device 43 can be provided between the discharging body and the counter electrode 44. It is to be noted that the configuration of the electrostatic charging unit is not particularly limited, and for example, the counter electrode 44 is not always required to be grounded, or may be applied with a high voltage. In addition, in place of providing the counter electrode 44, a belt portion of the carrying conveyor 41 may be, for example, constituted of a conductor.

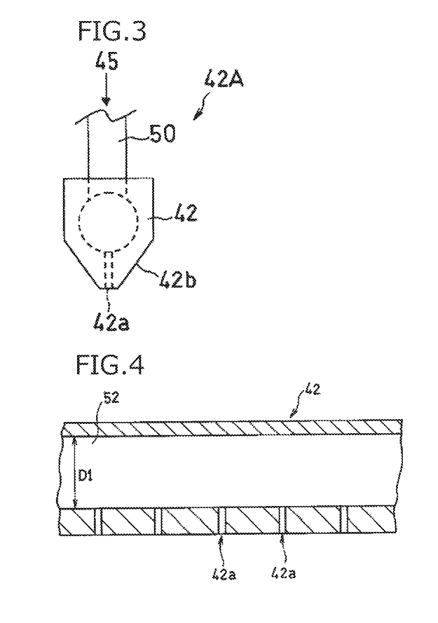

FIG. 2 is a front view diagrammatically illustrating the discharge portion 42A of FIG. 1, and FIG. 3 is a side view diagrammatically illustrating the discharge portion 42A of FIG. 1. FIG. 4 is a partially enlarged, diagrammatic cross-sectional view of a discharging body 42 of FIGS. 2 and 3, which is cut by a plane passing through a discharge port 42a.

As shown in FIGS. 2 and 3, the discharge portion 42A has the discharging body 42 for discharging the raw material liquid, and a conduit 50 for supplying a raw material liquid 45 into the discharging body 42 is connected to an upper part of the discharging body 42. In addition, a non-illustrated blowing mechanism is provided in an upper portion of the discharging body 42. By blowing air from the upper portion of the discharging body 42 by the blowing mechanism, a solvent vapor or an ionic wind, which hinders the production of a nanofiber, can be efficiently ventilated.

The discharging body 42 has a lengthy shape, and a hollow cylindrical housing portion 52 having a diameter D1 is formed in the inside of the discharging body 42. A plurality of the discharge ports 42a are provided at fixed intervals in a regular arrangement on the side opposing a belt (base material) of the carrying conveyor 41 of the discharging body 42.

The upper part of the discharging body 42 is formed in a shape whose cross section is a square, and a tapered portion 42b in which a width of the cross-sectional shape becomes gradually small toward the discharge port 42a is formed. In this way, by forming the tapered portion 42b in the circumference of the discharge port 42a of the discharging body 42, the generation of an ionic wind due to concentration of electric charges in the corners or the like can be suppressed.

In addition, by making the width of the cross-sectional shape of the discharging body 42 gradually small toward the discharge port 42a, the electric charges can be appropriately concentrated, and the electric charges can be efficiently supplied into the raw material liquid to be discharged from the discharge port 42a. A diameter of a through-hole communicating the housing portion 52 and the discharge port 42a with each other is, for example, 0.25 to 0.4 mm, and a length of the through-hole is, for example, 0.1 to 5 mm. As for a cross-sectional shape of the through-hole, an arbitrary shape, such as a circle; a polygon, e.g., a triangle, a quadrilateral, etc.; a shape having a portion which is projected in the inside thereof, e.g., a star shape, etc.; etc., can be chosen.

The raw material liquid 45 is supplied into the housing portion 52 of the discharge body 42 from a raw material liquid tank 45a through the conductor 50 due to a pressure of a pump 46 communicating with a hollow portion of the discharging body 42. Then, the raw material liquid 45 is discharged from the plural discharge ports 42a toward the principal surface of the nonwoven fabric F due to the pressure of the pump 46. The discharged raw material liquid causes electrostatic explosion during the movement in an electrically charged state in a space between the discharging body 42 and the carrying conveyor 41 (or the nonwoven fabric F), thereby producing a nanofiber having a sheath-core structure. The produced nanofiber is attracted onto the principal surface of the base material by electrostatic attraction and accumulated thereon. There is thus formed the nonwoven fabric F.

The belt portion of the carrying conveyor 41 may be a dielectric. In the case where the belt portion is constituted of a conductor, there is a tendency that the nanofiber is concentrated in some extent and accumulated in the collector close to the discharge port of the discharging body 42. From the viewpoint of more uniformly dispersing the nanofiber in the collector portion, it is more desired to form the belt portion of the carrying conveyor 41 by a dielectric.

In the case of forming the belt portion by a dielectric, the counter electrode 44 may be brought into contact with the inner circumferential surface of the belt portion (the surface on the opposite side to the surface coming into contact with the nonwoven fabric F). According to such contact, dielectric polarization occurs in the inside of the belt portion, and uniform electric charges are generated on the contact surface with the base material E. According to this, the possibility that the nanofiber is concentrated and accumulated in a part of a surface Ea of the base material E is more reduced.

In FIG. 1, in a place where the nonwoven fabric F and the belt of the carrying conveyor 41 are separated (exfoliated) from each other, in order to suppress the generation of a spark, which is possibly caused at the time when these are exfoliated from each other, a destaticizing device for subjecting the nonwoven fabric F to electricity removal may be provided. In addition, in the vicinity of a window portion between the nonwoven fabric-forming apparatus 40 and each of the adjacent apparatuses thereto, a suction duct for ventilating the electrically charged solvent vapor as generated in a spinning space and the electrically charged air, thereby enhancing a spinning performance may be provided.

The accomplished nonwoven fabric F as carried out from the nonwoven fabric-forming apparatus 40 is recovered into the recovery apparatus 70 via a carrying roller 71. The recovery apparatus 70 has a recovery reel 72 for winding up the carried nonwoven fabric F built-in. The recovery reel 72 is rotary-driven by a motor 74.

In the production system shown in FIG. 1, the motor 74 for rotating the recovery apparatus 70 for recovering the nonwoven fabric is controlled to such a rotation rate that a carrying rate of the nonwoven fabric F (rate of the carrying conveyor 41) becomes constant. According to this, the nonwoven fabric F is carried while keeping a prescribed tension. Such control is performed by a control device (not shown) provided in the production system. The control device is configured such that it is able to integrally control and manage the respective apparatuses configuring the production system.

A preliminary recovery portion may be disposed between the nonwoven fabric-forming apparatus 40 and the nonwoven fabric recovery apparatus 70. The preliminary recovery portion is provided such that the recovery of the accomplished nonwoven fabric F by the recovery apparatus 70 becomes easy. Specifically, in the preliminary recovery portion, the accomplished nonwoven fabric F as carried out from the nonwoven fabric-forming apparatus 40 is recovered in a slack state without being wound up until it reaches a fixed length. In the meantime, the recovery reel 72 of the recovery apparatus 70 is stopped without being rotated. Then, every time when the length of the nonwoven fabric F in a slack state, as recovered by the preliminary recovery portion reaches a fixed length, the recovery reel 72 of the recovery apparatus 70 is rotated for a prescribed time, and the nonwoven fabric F is wound up by the recovery reel 72.

By providing such a preliminary recovery portion, it becomes unnecessary to control the production system by strictly operating the carrying rate of the carrying conveyor 41 together with the rotation rate of the motor 74 with which the nonwoven fabric recovery apparatus 70 is provided, so that the control device of the production system can be simplified.

It is to be noted that the above-described production system of a nonwoven fabric is merely an example of the production system which can be adopted for carrying out the production method of a nonwoven fabric according to an embodiment of the present disclosure. The production method of a nonwoven fabric is not particularly limited so long as it includes a first step of preparing a first solution; and a second step of producing a nanofiber from the first solution in a nanofiber-forming space and accumulating the produced nanofiber, thereby forming a nonwoven fabric,

In addition, with respect to the second step, so long as it is a step of producing a nanofiber by an electrostatic force from the first solution in a prescribed nanofiber-forming space and accumulating the produced nanofiber, any electric field spinning mechanism may be adopted. For example, the shape of the discharging body is not particularly limited. A shape of a cross section perpendicular to the length direction of the discharging body is not limited to a shape that gradually becomes small from the upper portion toward the lower portion (V-type nozzle) as shown in FIG. 3, but the discharging body may be configured of a rotary body.

In the nanofiber forming apparatus, by continuously accumulating a fiber on the principal surface of the belt of the carrying conveyor, a lengthy nonwoven fabric can be formed. In addition, by intermittently performing the accumulation of a nanofiber, a rectangular nonwoven fabric can also be formed.

### (Air Purifier)

An air purifier according to an embodiment of the present disclosure has only to be provided with the above-described nonwoven fabric as a filter material, and other constituent elements can be configured of those which are known. The air purifier may be, for example, provided with a suction portion of a gas (specifically, air), an ejection portion of a gas, and the nonwoven fabric disposed therebetween. The filter material may be configured of a single sheet of nonwoven fabric, or may be configured of a lamination of two or more sheets of nonwoven fabrics.

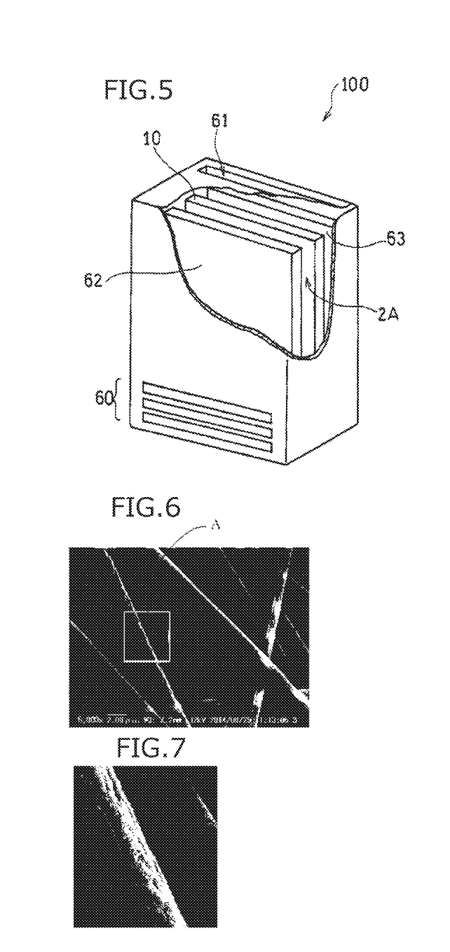

FIG. 5 is a partially cutaway perspective view illustrating an air purifier according to an embodiment of the present disclosure.

An air purifier 100 is provided with a nonwoven fabric 10, a suction portion 60 of a gas, and an ejection portion 61 of a gas. The nonwoven fabric 10 is disposed between the suction portion 60 and the ejection portion 61 such that a primary surface 2A is opposed to the suction portion 60. The nonwoven fabric 10 may be disposed upon being pleated in a bellows shape.

The air purifier 100 takes fresh air in the inside of the air purifier 100 from the suction portion 60. The air taken is subjected to dust collection during passing through the filter material (nonwoven fabric) 10 or the like, and the purified air is again released outside from the ejection portion 61. On the occasion that the air passes through the nonwoven fabric 10, a fine dust contained in the air is physically removed by the nonwoven fibrous structure of the nonwoven fabric 10 and also electrically removed by the electrically charged nanofiber. If desired, a known catalyst and/or a known additive (e.g., an adsorbent, etc.) or the like, which is used for a nonwoven fabric (or the filter material) in an air purifier, may be supported on the nonwoven fabric 10.

The air purifier 100 may be further provided with a prefilter 62 for capturing a large dust, etc., or the like between the suction portion 60 and the nonwoven fabric 10. In addition, a deodorizing filter 63, a humidifying filter (not shown), or the like may be provided between the nonwoven fabric 10 and the ejection portion 61.

### EXAMPLES

The present disclosure is hereunder specifically described on the basis of Example and Comparative Examples, but it should not be construed that the present disclosure is limited to the following Examples.

### Example 1

### (1) Preparation of Polymer Solutions

PES as a first polymer was dissolved in DMAc, thereby preparing a first polymer solution containing PES in a concentration of 20% by mass. The PES used had plural peaks in a molecular weight range of from 30,000 to 120,000 and had an M_{w} of 75,000 and an M_{w}/Mₙ ratio of 2.4. In addition, the PES had a dielectric constant of about 3.5 and a volume resistivity of 10¹⁵Ω·cm.

PP as a second polymer was dissolved in methylcyclohexane, thereby preparing a second polymer solution containing PP in a concentration of 20% by mass. The PP used had an M_{w} of 70,000 and an M_{w}/Mₙ ratio of 2. The PP had a dielectric constant of about 2.5 and a volume resistivity of 10¹⁶Ω·cm.

### (2) Mixing of Polymer Solutions

The first polymer solution and the second polymer solution were mixed in a proportion such that a mass ratio of the first polymer to the second polymer was 1/1 and stirred with a planetary mixer at a stirring rate (revolution rate) of 1,000 rpm for 8 minutes.

### (3) Separation of First Solution

The mixture obtained in the above-described (2) was transferred into a separating funnel and allowed to stand for 4 hours. As a result, the mixture was separated into two phases of an upper layer containing methylcyclohexane and a lower layer containing DMAc. It is to be noted that though a time of allowing this mixture to stand for phase separation requires 10 minutes at minimum, it is desirably one hour or more. The lower layer was removed using a separating funnel, and the solution of the upper phase was recovered. The components of the solution of the upper phase were analyzed by means of high-performance liquid chromatography. As a result, the solution of the upper phase contained both PES and PP. As a result of examining a molecular weight distribution of PES contained in the solution of the upper phase, the PES had an M_{w} of 64,000 and an M_{w}/Mₙ ratio of 1.3.

### (4) Electric Field Spinning

In accordance with the production system as shown in FIG. 1, the solution (first solution) obtained in the above-described (3) was used as a raw material liquid and subjected to electric field spinning under the following conditions to accumulate a nanofiber on a principal surface of a base material, thereby preparing a nonwoven fabric.

### Electric Field Spinning Conditions

Applied voltage: 50 kV

Ejection pressure of solution: 20 kPa

Temperature: 26° C.

Humidity: 57% RH

In the resulting nonwoven fabric, an average fiber diameter of the nanofiber was 795 nm. In addition, the nonwoven fabric had a thickness of 300 μm and a mass per unit area of 0.8 g/m².

Electron microscopic photographs of the resulting nonwoven fabric are shown in FIGS. 6 and 7. FIG. 7 is an enlarged view of a portion A surrounded by a square in FIG. 6.

### (5) Evaluation:

The nonwoven fabric was evaluated with respect to dust collection efficiency and pressure loss according to the following procedures.

### (a) Dust Collection Efficiency (Counting Method):

The nonwoven fabric was cut into a size of 12 cm in length and 12 cm in width and provided as a sample. An air dust was sucked on this sample at a surface wind velocity of 5.3 cm/sec. A dust concentration (number of dusts) on the upstream side of the sample and a dust concentration (number of dusts) on the downstream side of the sample were defined as C₀ and C₁, respectively, and a dust collection efficiency (=1−C₁/C₀)×100(%) was calculated. A concentration of the number of dusts was determined with a light scattering automatic particle counter.

### (b) Pressure Loss:

The dust collection test was performed in the same manner as that in the above-described (a), an air pressure P₀ on the upstream side of the sample and an air pressure P₁ on the downstream side of the sample were measured, and a pressure loss (=P₀−P₁) was calculated. For the measurement of the air pressure, a monometer was used in conformity with the standards of JIS B9908, Form 1 (counting method).

### Comparative Example 1

A nonwoven fabric was prepared and evaluated in the same manner as that in Example 1, except for performing the electric field spinning by using the first polymer solution as the raw material liquid in place of the first solution. The resulting nonwoven fabric had a thickness of 300 μm and a mass per unit area of 0.9 g/m², and an average fiber diameter of the fiber was 832 nm.

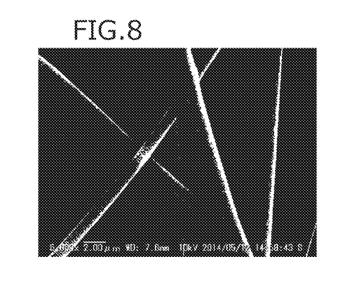

An electron microscopic photograph of the nonwoven fabric is shown in FIG. 8.

### Comparative Example 2

The same operations as those in Example 1 were followed, except for trying the electric field spinning by using the second polymer solution in place of the first solution. However, a fiber could not be formed.

The results of the Example and Comparative Examples are shown in Table 1.

TABLE 1

| | DUST COLLECTION | PRESSURE LOSS |
|---|---|---|
| | EFFICIENCY(%) | (PA) |
| EXAMPLE 1 | 98.8 | 14.7 |
| COMPARATIVE | 89.3 | 16.7 |
| EXAMPLE 1 | | |

As shown in Table 1, in Example 1, a high dust collection efficiency was obtained while suppressing the pressure loss, as compared with Comparative Example 1.

As shown in FIG. 8, the surfaces of the fibers of the nonwoven fabric of Comparative Example 1 are smooth. On the other hand, as shown in FIG. 7, in the fibers of the nonwoven fabric of Example 1, the sheath portion of PP was formed so as to cover the surface of the core portion formed of PES here and there. In view of the fact that the sheath portion was formed, unevenness was formed on the fiber surface of the nonwoven fabric of Example 1, different from Comparative Example 1. In view of the existence of this unevenness and PP with high electrostatic on the surface, it may be considered that in Example 1, a high dust collection effect was obtained as compared with Comparative Example 1.

### INDUSTRIAL APPLICABILITY

In accordance with the nonwoven fabric according to an embodiment of the present disclosure, even when used over a long period of time, it is possible to reveal high dust collection efficiency and to suppress an increase of pressure loss. For that reason, the nonwoven fabric according to an embodiment of the present disclosure can be applied to an air purifier (in particular, as a filter material) for household use or office use, or the like, for which quietness is required. However, the application of the nonwoven fabric of the present disclosure is not limited to the filter material of an air purifier. For example, the nonwoven fabric of the present disclosure is applicable to, in addition to various filter materials, other applications, such as a separation sheet (separator) for battery, an in-vitro check sheet, e.g., a pregnancy check sheet, etc., a wiping sheet for wiping off a dust or a stain, or the like, a base material, etc.

What is claimed is:

1. A nonwoven fabric comprising:
a nanofiber comprising a core portion and a sheath portion covering at least a part of a surface of the core portion,
wherein the core portion comprises a first polymer;
wherein the sheath portion comprises a second polymer; and
wherein the second polymer is smaller in polarity or in dielectric constant than the first polymer.

2. The nonwoven fabric according to claim 1, wherein the nanofiber is formed by an electric field spinning method.

3. The nonwoven fabric according to claim 1, wherein an amount of the second polymer is 10 to 1,000 parts by mass based on 100 parts by mass of the first polymer.

4. The nonwoven fabric according to claim 1, wherein the nanofiber has an exposed portion where at least a part of the surface of the core portion is exposed.

5. The nonwoven fabric according to claim 4, wherein in the surface of the core portion, an area of the exposed portion is greater than an area of the sheath portion.

6. A nonwoven fabric comprising:
a nanofiber comprising a core portion and a sheath portion covering at least a part of a surface of the core portion;
wherein the core portion comprises a first polymer;
wherein the sheath portion comprises a second polymer;
wherein the second polymer is a polyurethane; and
wherein the first polymer is a polymer that is higher in hydrolysis resistance than the second polymer.

7. The nonwoven fabric according to claim 6, wherein an average of D_{f}/D_{c} that is a ratio of a fiber diameter D_{f} of the nanofiber to a diameter D_{c} of the core portion is 1.4 to 5.

8. An air purifier, comprising:
a suction portion for gas;
an ejection portion for the gas; and
the nonwoven fabric according to claim 1, which is disposed between the suction portion and the ejection portion.

9. A method for producing a nonwoven fabric, comprising
a first step of preparing a first solution containing a first polymer or a precursor of the first polymer and a second polymer having smaller polarity than the first polymer; and
a second step of producing a nanofiber by an electrostatic force from the first solution in a nanofiber-forming space and accumulating the produced nanofiber, thereby forming a nonwoven fabric,
wherein the nanofiber comprises a core portion and a sheath portion covering at least a part of a surface of the core portion;
wherein the core portion comprises the first polymer; and
wherein the sheath portion comprises the second polymer.

10. The method for producing a nonwoven fabric according to claim 9, wherein the first step comprises:
a step (a) of preparing a first polymer solution comprising the first polymer and a first solvent for dissolving the first polymer;
a step (b) of preparing a second polymer solution comprising the second polymer and a second solvent for dissolving the second polymer therein;
a step (c) of mixing the first polymer solution and the second polymer solution; and
a step (d) of separating a solution comprising the first polymer and the second polymer as the first solution from a mixture obtained in the step (c).

11. The method for producing a nonwoven fabric according to claim 10, wherein the second solvent is smaller in polarity than the first solvent.

12. The method for producing a nonwoven fabric according to claim 10, wherein the first polymer comprised in the first polymer solution has plural peaks in a molecular weight distribution.

13. The method for producing a nonwoven fabric according to claim 9, wherein a molecular weight distribution width of the first polymer comprised in the first solution is narrower than a molecular weight distribution width of the second polymer.
